(19) United States
(12) Patent Application Publication
(10) Pub. No.: US 2023/0109639 A1
(43) Pub. Date: Apr. 6, 2023

(54) GROWTH POTENTIAL ESTIMATION SYSTEM, GROWTH POTENTIAL ESTIMATION DEVICE, GROWTH POTENTIAL ESTIMATION METHOD, AND RECORDING MEDIUM IN WHICH GROWTH POTENTIAL ESTIMATION PROGRAM IS STORED

(71) Applicant: NEC Corporation, Minato-ku, Tokyo (JP)

(72) Inventor: Ryosuke TOGAWA, Tokyo (JP)

(73) Assignee: NEC Corporation, Minato-ku, Tokyo (JP)

(21) Appl. No.: 17/907,807

(22) PCT Filed: Mar. 27, 2020
(86) PCT No.: PCT/JP2020/013910

§ 371 Date: Aug. 29, 2022

(51) Int. Cl. G06N 7/01; G06Q 10/063

(52) U.S. Cl. CPC G06N 7/01; G06Q 10/063

(57) ABSTRACT

A growth potential estimation system 30 is provided with: an estimation model 31 that represents a relationship between transaction information 310 (representing a time-series change of company-to-company transaction relations of an intended company), account time-series information 313 (representing a time-series change of deposits and withdrawals of accounts of the intended company), and intended company attribute information 314 (representing a time-series change of the attribute of the intended company) of the intended company for a first period and the growth potential 315 of the intended company after the first period; and an estimation unit 32 for estimating the growth potential of the intended company after a second period on the basis of transaction information 300, account time-series information 303, and company attribute information 304 for a second period that is later than the first period.

### TECHNICAL FIELD

The present invention relates to a growth potential estimation system, a growth potential estimation device, a growth potential estimation method, and a recording medium in which a growth potential estimation program is stored.

### BACKGROUND ART

Estimating (predicting) the growth potential of a company is very important in formulating a growth strategy by the company itself, in determining whether to provide a loan to the company by a bank, or in determining whether to make an investment in the company by an investor. Therefore, a technique for improving the accuracy of estimating the growth potential of a company is expected.

As a technique related to such a technique, PTL 1 discloses a system for predicting a business failure probability of a company. This system calculates a score value for each item category by performing regression analysis based on quantification theory class 1 using, as a target variable, a failure probability actual value after logit conversion obtained by logit conversion of a failure probability actual value for each classification data for each category set. Then, this system calculates a logit value L for the designated item category, and calculates a failure probability P=1/(1+e^{-L}) (where, e represents the base of the natural logarithm). Note that the logit value L is calculated by “Score group score value+Industry group score value+Growth potential group score value+Interest rate group score value+Exchange group score value+Price group score value+Government group score value+Constant number value”.

In addition, PTL 2 discloses a device that performs comprehensive business value evaluation from the viewpoint of stability, growth potential, and continuity of an intended company. The device calculates an intended company power index and calculates a predicted life span of the intended company. This device calculates an average value of the added value amounts of the latest number of predetermined mandates of the intended company, and calculates a value added growth potential of the intended company. The device calculates a value added growth potential of the intended company in each year, and estimates a value added growth potential maintaining period until the year in which the value added growth potential of the intended company falls below a predetermined value. The device calculates a first present value until the estimated value added growth potential maintaining period based on the average value of the value added amounts of the intended company and the value added growth potential in each year. The device calculates a second present value after the lapse of the value added growth potential maintaining period based on the calculated average value of the value added amounts of the intended company and the average value added growth potential. Then, the device calculates an enterprise value by adding the first present value and the second present value.

PTL 3 discloses a system that predicts future financial conditions of a company or the like and measures a credit risk of the company or the like from the result. The system calculates the amount of change in net assets for a particular corporation in the future period (t+1) based on historical financial data of the particular corporation that produces the financial statements. The system extracts changes in financial data from a period (t−1) prior to the immediately preceding period (t) to an immediately preceding period (t) for a particular corporation and selects a financial strategy pattern for the immediately preceding period (t). The system identifies a financial strategy pattern of the future period (t+1) associated to the financial strategy pattern of the immediately preceding period (t) based on a financial strategy map, and identifies a financial balance factor by the financial strategy pattern of the future period (t+1) and the financial strategy pattern of the immediately preceding period (t). Then, this system calculates the amounts of change in other items in the balance sheet in the future period (t+1) based on the specified financial balance coefficient and the amount of change in the net assets in the future period (t+1), and calculates the balance sheet in the future period (t+1).

### CITATION LIST

### Patent Literature

[PTL 1] JP 2008-250466 A
[PTL 2] JP 2009-087219 A
[PTL 3] JP 2010-134840 A

### Non Patent Literature

[NPL 1] Lu Wang, Wenchao Yu, Wei Wang, Wei Cheng, Wei Zhang, Hongyuan Zha, Xiaofeng He, Haifeng Chen, “Learning Robust Representations with Graph Denoising Policy Network”, arXiv:1910.01784, Oct. 4, 2019
[NPL 2] Dongkuan Xu, Wei Cheng, Dongsheng Luo, Xiao Liu, Xiang Zhang, “Spatio-Temporal Attentive RNN for Node Classification in Temporal Attributed Graphs”, Twenty-Eighth International Joint Conference on Artificial Intelligence Main track, Pages 3947-3953, Aug. 11-12, 2019
[NPL 3] Wenchao Yu, Wei Cheng, Charu Aggarwal, Kai Zhang, Haifeng Chen, Wei Wang, “NetWalk: A Flexible Deep Embedding Approach for Anomaly Detection in Dynamic Networks”, KDD 2018, August 19-23, 2018, London, United Kingdom

### SUMMARY OF INVENTION

### Technical Problem

In order to estimate whether the intended company for which the growth potential is to be estimated will grow with high accuracy, it is necessary to estimate based on various growth factors that complicatedly affect each other. Such growth factors include, for example, a feature of a time-series change (transition) in a transaction relation between the intended company and a transaction company having a transaction relation, a feature of a time-series change in an attribute related to a company activity of the intended company or the transaction company, and the like. Therefore, in order to estimate the growth potential of the intended company with high accuracy, it is necessary to perform analysis after grasping the features of the time-series change regarding such company activities with high accuracy.

However, in a general system that estimates the growth potential of an intended company, since the features of the time-series change regarding the company activity cannot be sufficiently grasped, in particular, in a case where the features of the time-series change are important factors in the growth potential of the company, the estimation accuracy of the growth potential greatly decreases. It cannot be said that the techniques disclosed in PTLs 1 to 3 described above are sufficient to solve this problem.

A main object of the present invention is to provide a growth potential estimation system and the like capable of improving accuracy of estimating a growth potential of a company.

### Solution to Problem

A growth potential estimation system according to an aspect of the present invention includes: an estimation means configured to estimate a growth potential of an intended company after a second period based on an estimation model representing a relation between transaction information, account time-series information, and intended company attribute information of the intended company in a first period, and a growth potential of the intended company after the first period, and the transaction information, the account time-series information, and the intended company attribute information in the second period after the first period. The transaction information represents a time-series change in a company-to-company transaction relation of the intended company. The account time-series information represents a time-series change in deposits and withdrawals of account of the intended company. The intended company attribute information represents a time-series change in an attribute of the intended company.

In another aspect of achieving the above object, a growth potential estimation method according to the aspect of the present invention includes estimating, by an information processing system, a growth potential of an intended company after a second period based on an estimation model representing a relation between transaction information, account time-series information, and intended company attribute information of the intended company in a first period, and a growth potential of the intended company after the first period, and the transaction information, the account time-series information, and the intended company attribute information in the second period after the first period. The transaction information represents a time-series change in a company-to-company transaction relation of the intended company. The account time-series information represents a time-series change in deposits and withdrawals of account of the intended company. The intended company attribute information represents a time-series change in an attribute of the intended company.

From a further viewpoint of achieving the above object, a growth potential estimation program according to an aspect of the present invention causes a computer to execute: estimating processing of estimating a growth potential of an intended company after a second period based on an estimation model representing a relation between transaction information, account time-series information, and intended company attribute information of the intended company in a first period, and a growth potential of the intended company after the first period, and the transaction information, the account time-series information, and the intended company attribute information in the second period after the first period. The transaction information represents a time-series change in a company-to-company transaction relation of the intended company. The account time-series information represents a time-series change in deposits and withdrawals of account of the intended company. The intended company attribute information represents a time-series change in an attribute of the intended company.

Further, the present invention can also be achieved by a computer-readable non-volatile recording medium in which a growth potential estimation program (computer program) is stored.

### Advantageous Effects of Invention

According to the present invention, a growth potential estimation system and the like capable of improving the accuracy of estimating the growth potential of a company are obtained.

### BRIEF DESCRIPTION OF DRAWINGS

FIG. 1 is a block diagram illustrating a configuration of a growth potential estimation system 10 according to a first example embodiment of the present invention.

FIG. 2 is a diagram illustrating content of learning transaction result information 101 according to the first example embodiment of the present invention.

FIG. 3 is a diagram illustrating content of transaction company attribute information 102 according to the first example embodiment of the present invention.

FIG. 4 is a diagram illustrating content of account time-series information 103 according to the first example embodiment of the present invention.

FIG. 5 is a diagram illustrating content of intended company attribute information 104 according to the first example embodiment of the present invention.

FIG. 6 is a diagram illustrating a configuration of a graph 120 according to the first example embodiment of the present invention.

FIG. 7 is a flowchart illustrating an operation (processing) of generating (performing machine learning) an estimation model 130 by the growth potential estimation system 10 according to the first example embodiment of the present invention.

FIG. 8 is a diagram illustrating a mode in which an estimation unit 14 according to the first example embodiment of the present invention displays an estimation result on a display screen 200.

FIG. 9 is a flowchart illustrating estimation operation of the growth potential estimation system 10 according to the first example embodiment of the present invention.

FIG. 10 is a block diagram illustrating a configuration of a growth potential estimation system 30 according to a second example embodiment of the present invention.

FIG. 11 is a block diagram illustrating a configuration of an information processing system 900 capable of executing the growth potential estimation system 10 according to the first example embodiment or the growth potential estimation system 30 according to the second example embodiment of the present invention.

### EXAMPLE EMBODIMENT

A system exemplifying an example embodiment to be described later uses a learned model (also referred to as an estimation model) generated by machine learning (for example, deep learning) when estimating a target event from certain input information. Then, the system uses, for example, a graph including a node and an edge (also referred to as a branch) representing the input information. The graph changes in structure over time. The system has been conceived of applying an algorithm capable of analyzing features of such a graph. As this algorithm, for example, the following algorithm is known.

(1) TGFN (Temporal Graph Factorization Network)

It is an algorithm that extracts a static feature that is unchanged regardless of time and a dynamic feature unique to each time from a graph whose structure changes with the lapse of time, and analyzes the extracted feature. Since this algorithm is disclosed in NPL 1, the detailed description thereof will be omitted in the example embodiment described later.

(2) STAR (Spatio-Temporal Attentive RNN)

It is an algorithm for identifying and analyzing, from a graph whose structure changes with the lapse of time, a node that is important (that is, the degree of influence on estimation is high) in estimation of a certain event, for example, on each of a time axis and a spatial axis among nodes constituting the graph. Since this algorithm is disclosed in NPL 2, the detailed description thereof will be omitted in the example embodiment described later.

(3) Netwalk

It is an algorithm for extracting a feature amount of a node constituting a graph from the graph whose structure changes with the lapse of time. Since this algorithm is disclosed in NPL 3, the detailed description thereof will be omitted in the example embodiment described later.

The disclosure exemplifying the example embodiment to be described later achieves improvement in accuracy of estimating a target event by applying the above-described algorithm when generating a learned model and when estimating the target event from certain input information using the learned model.

Hereinafter, example embodiments of the present invention will be described in detail with reference to the drawings.

### First Example Embodiment

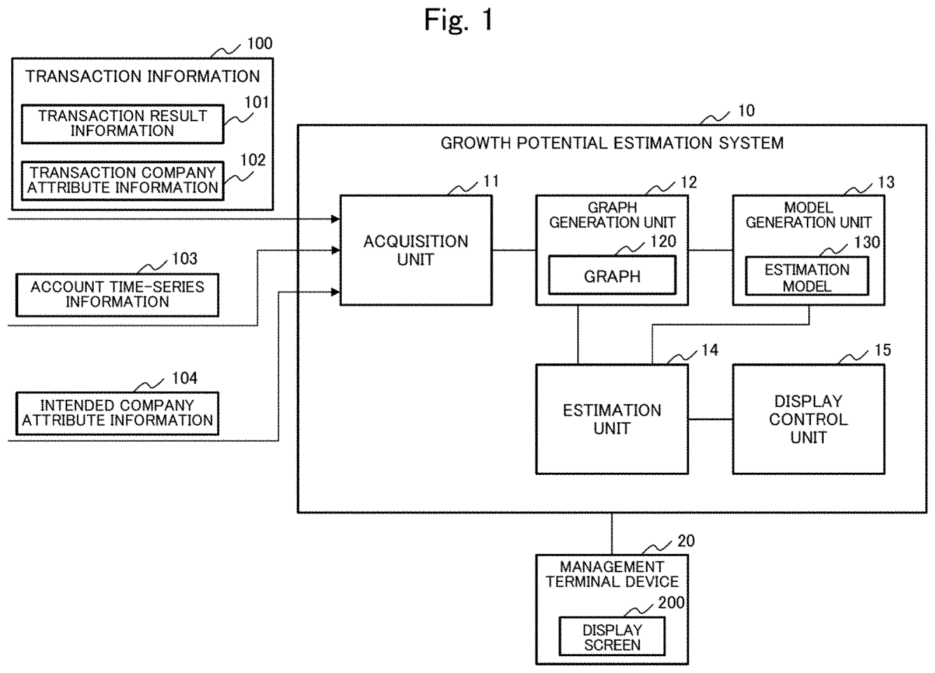

FIG. 1 is a block diagram illustrating a configuration of a growth potential estimation system 10 according to a first example embodiment of the present invention. The growth potential estimation system 10 according to the present example embodiment is a system that estimates a growth potential of an intended company on the basis of information regarding a company activity, an attribute, or the like of the intended company. For the intended company in the past, the growth potential estimation system 10 generates a learned model (also referred to as an estimation model) by using information regarding company activities, attributes, and the like for which growth records are given as labels, and estimates the future growth potential of the intended company by using the trained model. The growth potential estimation system 10 includes at least one or more information processing devices.

A management terminal device 20 (also referred to as a display device) is communicably connected to the growth potential estimation system 10. The management terminal device 20 is, for example, a personal computer or another information processing device used when a user using the growth potential estimation system 10 inputs information to the growth potential estimation system 10 or confirms information output from the growth potential estimation system 10. The management terminal device 20 includes a display screen 200 that displays the information output from the growth potential estimation system 10.

The growth potential estimation system 10 includes an acquisition unit 11, a graph generation unit 12, a model generation unit 13, an estimation unit 14, and a display control unit 15. The graph generation unit 12, the model generation unit 13, the estimation unit 14, and the display control unit 15 are examples of a graph generation means, a model generation means, an estimation means, and a display control means in order.

Next, an operation in which the growth potential estimation system 10 according to the present example embodiment generates or updates an estimation model 130 for estimating the growth potential of the intended company and an operation in which the growth potential of the intended company is estimated using the generated or updated estimation model 130 will be described.

<Operation of Generating (Updating) Estimation Model>

First, an operation in which the growth potential estimation system 10 according to the present example embodiment generates or updates an estimation model for estimating the growth potential of the intended company will be described.

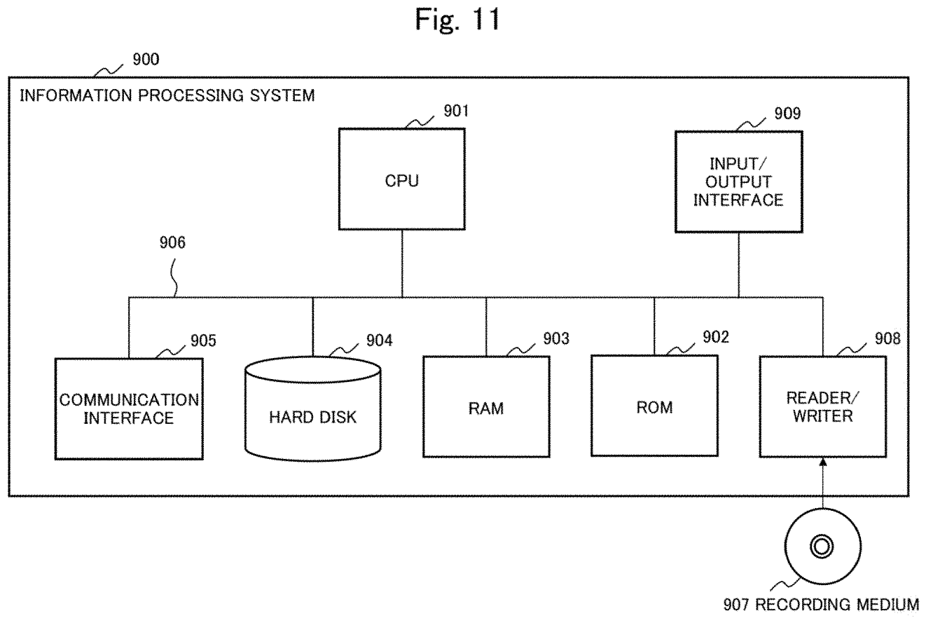

The acquisition unit 11 acquires transaction information 100, account time-series information 103, and intended company attribute information 104 about the intended company from a computer device (not illustrated) or a database via a network. For example, the acquisition unit 11 may acquire the transaction information 100, the account time-series information 103, and the intended company attribute information 104 according to an instruction input by the user via the management terminal device 20. Acquisition unit 11 includes, for example, a communication circuit connected to one or more computer devices or databases that transmit the transaction information 100, the account time-series information 103, and the intended company attribute information 104, and a storage device that stores information acquired by the communication circuit. The storage device may be a hard disk 904 or a RAM 903 of the information processing system 900 illustrated in FIG. 11 described later.

The transaction information 100 is information indicating a transition of a transaction relation between an intended company and a transaction company that is a customer of the intended company. The transaction information 100 includes transaction result information 101 and transaction company attribute information 102.

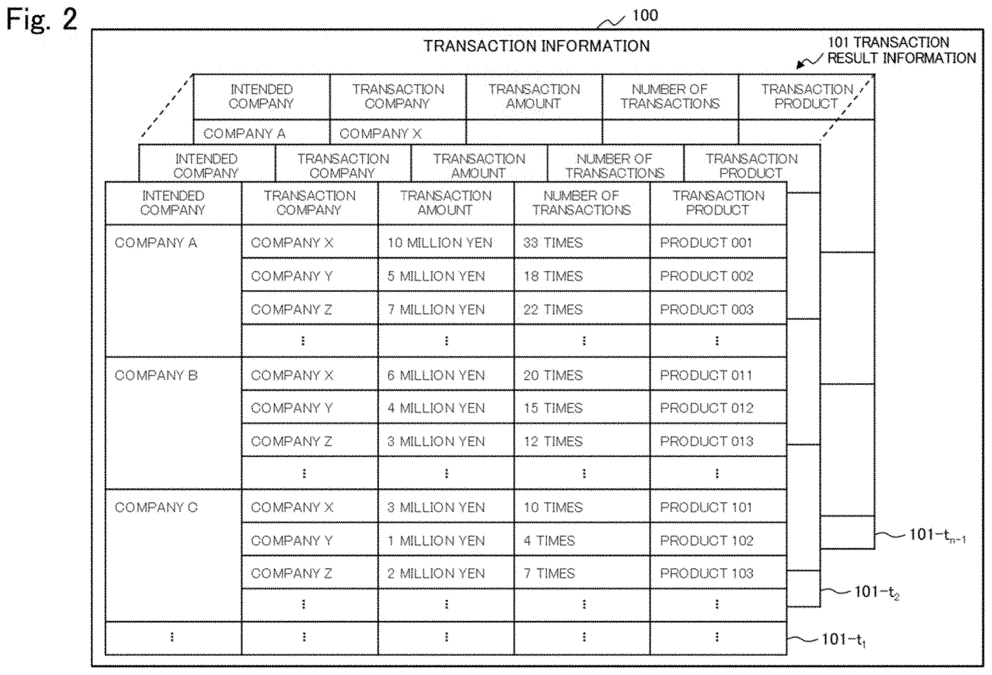

FIG. 2 is a diagram illustrating content of data of the transaction result information 101 according to the present example embodiment. The transaction result information 101 represents a transaction amount, the number of transactions, and a transaction product with each transaction company (Company X, Company Y, Company Z, etc.) for each intended company (Company A, Company B, Company C, etc.). Company A, Company B, and Company C are, for example, companies of the same industry type, and Company X, Company Y, and Company Z are companies having a transaction relation with a company of such an industry type. Note that the transaction result information 101 may include items indicating a transaction relation different from the transaction amount, the number of transactions, and the transaction product.

The transaction result information 101-t₁ to 101-tₙ₋₁ (where n is any integer equal to or more than 2) included in the transaction result information 101 sequentially represents the transaction amount, the number of transactions, and the transaction product with each intended company in the periods t₁ to tₙ₋₁. However, each of the periods t₁ to tₙ₋₁ represents a period in units of a predetermined length. The periods t₁ to tₙ₋₁ represent the order of time-series.

For example, in a case where the transaction information 100 represents information in units of one month, for example, the period t₁ represents January 2019, the period t₂ represents February 2019, and the period t₁₂ represents December 2019. Alternatively, for example, in a case where the transaction information 100 represents information in units of four quarters, the periods t₁ to t₄ represent, for example, the first quarter to the fourth quarter of 2019. As described above, the transaction result information 101 represents a transition of the transaction amount, the number of transactions, the transaction product, and the like between companies in units of a period of a certain length. Note that, in the following description of the present example embodiment, the periods t₁ to tₙ₋₁ and the like may be collectively referred to as a period t.

In the example illustrated in FIG. 2, for example, in a period t₁ (where i is any integer of 2 to n), in a case where the transaction relation between Company A of the intended company and Company X of the transaction company is resolved, the transaction result information 101 after the period t₁₊₁ does not include information indicating the transaction relation between Company A and Company X, that is, is deleted. Alternatively, for example, in a case where a transaction relation newly occurs between Company A and Company W in the period tⱼ (where j is any integer of 2 to n), information indicating the transaction relation between Company A and Company W is newly included, that is, added in the transaction result information 101 after the period tⱼ.

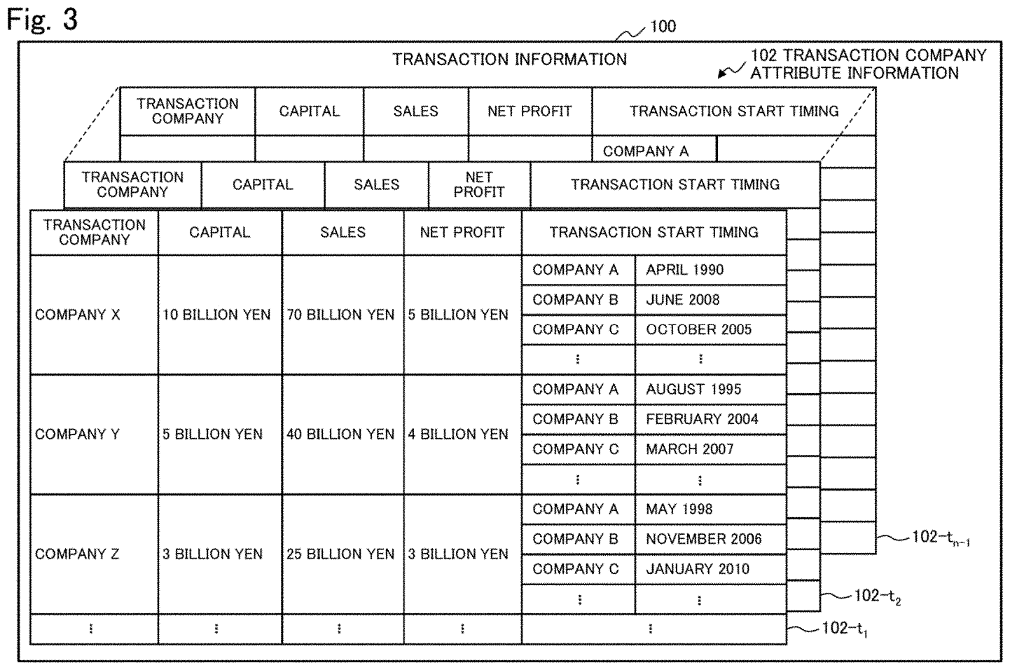

FIG. 3 is a diagram illustrating the content of the transaction company attribute information 102 according to the present example embodiment. The transaction company attribute information 102 indicates, as attributes of each transaction company, capital, sales, net profit, and transaction start timing with each intended company of each transaction company. Note that, in the example of FIG. 3, the transaction company attribute information 102 is illustrated as information including capital, sales, net profit, and transaction start timing with each intended company of each transaction company, but is not limited thereto. The transaction company attribute information 102 may include items regarding attributes of each transaction company different from capital, sales, net profit, and transaction start timing, or may be information including at least one of capital, sales, net profit, and transaction start timing. The transaction company attribute information 102 may include, for example, a transaction duration with each intended company, stock price information regarding an index of a stock price, financial information such as a total market value, a cash flow, a capital stock, and a capital stock ratio, and the like. Alternatively, for example, the transaction company attribute information 102 may include a business scale including the number of employees and the number of bases, a turnover rate, shareholder information, an industry type (manufacturer, financial, retail, etc.), and the like.

The transaction company attribute information 102-t₁ to 101-tₙ₋₁ included in the transaction company attribute information 102 sequentially represent capital, sales, net profit, and transaction start timing of the transaction company in the periods t₁ to tₙ₋₁. However, the transaction start timing is unchanged regardless of the period t. The capital is unchanged regardless of the period t unless capital increase or capital reduction is performed in a transaction company.

The tendency of the attribute of the transaction company indicated by the transaction company attribute information 102 to change in time-series is one of indices for estimating the growth potential of the intended company. For example, an intended company that frequently conducts transactions with a transaction company whose business performance (sales or net profit) is increasing can be expected to grow.

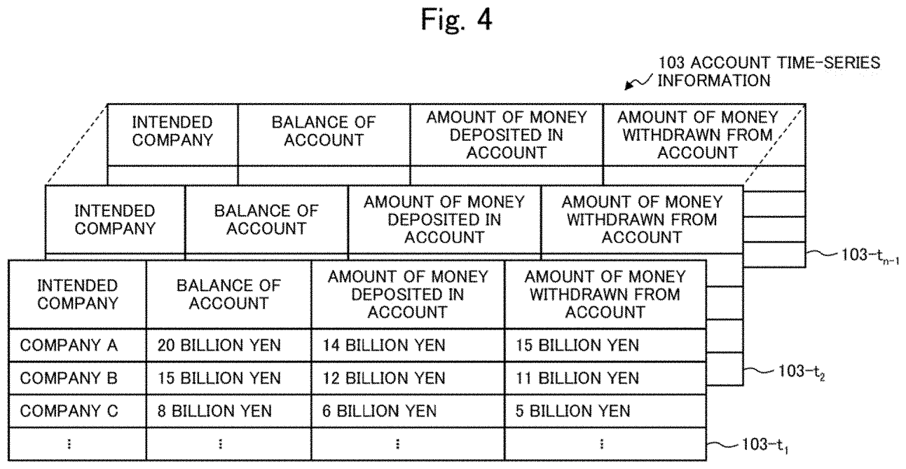

FIG. 4 is a diagram illustrating content of the account time-series information 103 according to the present example embodiment. The account time-series information 103 represents the balance of the account, the amount of money deposited in the account, and the amount of money withdrawn from the account for each intended company. Note that the account time-series information 103 may include items representing the state of the account different from the balance of the account, the amount of money deposited in the account, and the amount of money withdrawn from the account.

The account time-series information 103-t₁ to 103-tₙ₋₁ included in the account time-series information 103 sequentially represents the balance of the account, the amount of money deposited in the account, and the amount of money withdrawn from the account in the periods t₁ to tₙ₋₁.

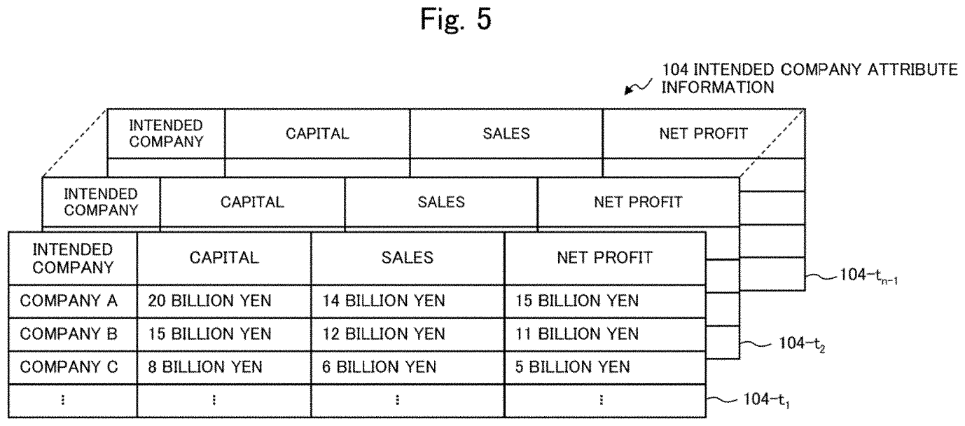

FIG. 5 is a diagram illustrating the content of the intended company attribute information 104 according to the present example embodiment. The intended company attribute information 104 illustrated in the example of FIG. 5 is information including capital, sales, and net profit for each intended company, but may be information including at least one of capital, sales, and net profit. Note that the intended company attribute information 104 may include items regarding attributes of each intended company different from capital, sales, and net profit. For example, the intended company attribute information 104 may include financial information such as a transaction duration with another company, stock price information regarding an index of a stock price, a total market value, a cash flow, a capital stock, and a capital stock ratio. Alternatively, for example, the intended company attribute information 104 may include a business scale including the number of employees and the number of bases, a turnover rate, shareholder information, an industry type (manufacturer, financial, retail, etc.), and the like. As described above, the intended company attribute information 104 may include any information regarding the attribute of the company.

The intended company attribute information 104-t₁ to 104-tₙ₋₁ included in the intended company attribute information 104 sequentially represent capital, sales, and net profit in the periods t₁ to tₙ₋₁. However, the capital is unchanged regardless of the period t unless capital increase or capital reduction is performed in the intended company.

The tendency of the attribute of the intended company indicated by the intended company attribute information 104 to change in time-series is one of indices for estimating the growth potential of the intended company. For example, an intended company whose business performance (sales or net profit) is increasing can be expected to continue to grow in the future.

The acquisition unit 11 stores the acquired transaction result information 101, the transaction company attribute information 102, the account time-series information 103, and the intended company attribute information 104 in the periods t₁ to tₙ₋₁ in a storage device (not illustrated) (for example, a memory, a hard disk, or the like).

The graph generation unit 12 illustrated in FIG. 1 generates a graph 120 representing the transaction result information 101, the transaction company attribute information 102, the account time-series information 103, and the intended company attribute information 104 in the periods t₁ to tₙ₋₁ acquired by the acquisition unit 11. Specifically, the graph generation unit 12 reads the transaction result information 101, the transaction company attribute information 102, the account time-series information 103, and the intended company attribute information 104 from the storage device, and generates the graph 120 based on a graph generation algorithm. In this case, the graph 120 represents a time-series change (transition of transaction) in the periods t₁ to tₙ₋₁ regarding the transaction relation between the intended company and the transaction company and the attributes of the intended company and the transaction company.

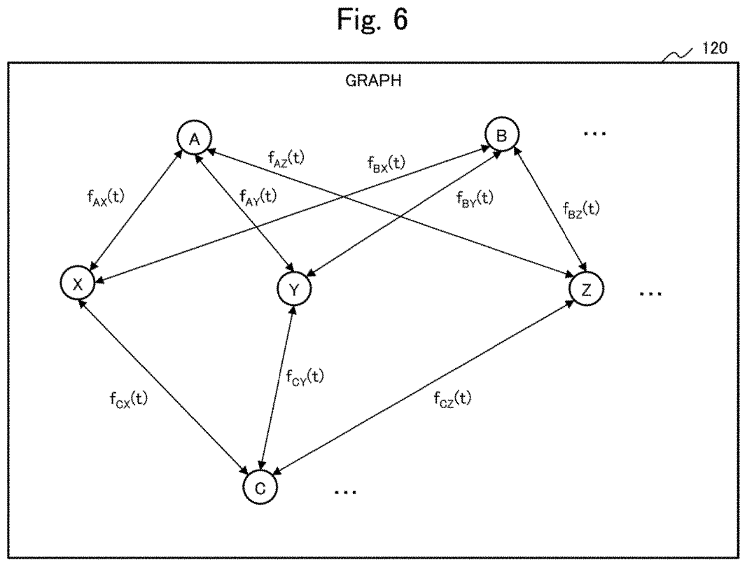

FIG. 6 is a diagram illustrating a configuration of the graph 120 according to the present example embodiment. As illustrated in FIG. 6, the graph 120 includes nodes representing the intended companies such as Company A, Company B, Company C, and the like and transaction companies such as Company X, Company Y, Company Z, and the like. Then, the graph 120 includes an edge that connects nodes representing a transaction relation between each intended company and each transaction company. In the example of FIG. 6, the node is indicated by a circle surrounding the company name of each intended company or each transaction company, and the edge is indicated by an oriented arrow, but the present invention is not limited thereto. For example, the edge may be represented by a line that does not indicate a direction, instead of an arrow.

Each node in the graph 120 includes attribute information of each intended company or each transaction company. More specifically, the node representing the intended company in the graph 120 includes the account time-series information 103 and the intended company attribute information 104. The node representing the transaction company in the graph 120 includes the transaction company attribute information 102. Therefore, each node is represented by a multi-dimensional function including the period t as a variable and the item (for example, capital, sales, net profit, and the like) included in each attribute information as an element. The multi-dimensional function representing a node is stored in a storage device (for example, the hard disk 904 or the RAM 903; not illustrated) in association with information indicated by the node for each period t (periods t₁, . . . , tₙ₋₁).

More specifically, each edge in the graph 120 is associated with the transaction result information 101. For example, an edge connecting a node indicating the intended company A and a node indicating the transaction company X represents a transaction relation between the intended company A and the transaction company X indicated by the transaction result information 101, and the transaction relation is represented by a function f_{AX}(t) illustrated in FIG. 6. Similarly, the transaction relation between the intended company B and the transaction company Y indicated by the transaction result information 101 is represented by a function f_{BY}(t) illustrated in FIG. 6. The function such as the function f_{AX}(t) representing each edge is a multi-dimensional function including the period t as a variable and the item (for example, the transaction amount, the number of transactions, and the transaction product) included in the transaction result information 101 as an element. The multi-dimensional function representing an edge is stored in a storage device (for example, the hard disk 904 or the RAM 903; not illustrated) in association with the edge for each period t (periods t₁, . . . , tₙ₋₁).

The graph generation unit 12 further assigns growth records of the intended companies A, B, C, and the like to the graph 120 generated for the periods t₁ to tₙ₋₁ as a label of teacher data used when the model generation unit 13 described later performs machine learning. For example, the graph generation unit 12 may obtain the growth record of the intended company from the transition of the sales and the net profit indicated by intended company attribute information 104 using a predetermined calculation rule. Alternatively, the graph generation unit 12 may obtain the growth record of the intended company by providing the stock price of the intended company or the evaluation information regarding the intended company by an external organization via the management terminal device 20 or the network.

For example, in a case where the periods t₁ to t₄ represent the first quarter to the fourth quarter of 2018, the graph generation unit 12 assigns the growth record of the intended company after the first quarter of 2019 as a label to the graph 120 generated for the period. The graph generation unit 12 stores, in the storage device, the configuration of the graph 120 generated for the periods t₁ to tₙ₋₁, which is a graph with growth records assigned as labels. The graph generation unit 12 outputs the graph 120 regarding the periods t₁ to t₄ to which the labels are assigned to the model generation unit 13 as teacher data. Then, in this case, the graph generation unit 12 assigns the growth record of the intended company after the second quarter of 2019, which is the period next to the period t₅, as a label to the graph 120 generated for the periods t₂ to t₅ (that is, the second quarter of 2018 to the first quarter of 2019). The graph generation unit 12 outputs the graph 120 regarding the periods t₂ to is to which the labels are assigned to the model generation unit 13 as teacher data.

As described above, the graph generation unit 12 sequentially assigns the growth record of the intended company after the period as a label to the graph 120 while changing the period (also referred to as the first period) for which the graph 120 is to be generated. Then, the graph generation unit 12 outputs the labeled graph 120 to the model generation unit 13 as teacher data.

The model generation unit 13 uses the labeled graph 120 input from the graph generation unit 12 as teacher data, and generates the estimation model 130 (learned model) used when the estimation unit 14 described later estimates the growth potential of the intended company. The model generation unit 13 performs machine learning for generating the estimation model 130 (learned model) using the above-described teacher data by a processor.

Specifically, the model generation unit 13 extracts, from the input graph 120, features of transition regarding a transaction relation between the intended company and the transaction company and attributes of the intended company and the transaction company, using a predetermined algorithm. The model generation unit 13 can use, for example, TGFN, STAR, Netwalk, or the like described above as the predetermined algorithm.

The model generation unit 13 extracts, from the graph 120, static features and dynamic features that change with time regarding a transaction relation between the intended company and the transaction company and attributes of the intended company and the transaction company by using, for example, TGFN. Alternatively, for example, by using STAR, the model generation unit 13 extracts nodes that are important (that is, the degree of influence on estimation is high) in the estimation of the growth potential of the intended company on each axis of the time axis (a viewpoint extending over a plurality of periods t) and the spatial axis (a viewpoint focusing on each period t). Alternatively, the model generation unit 13 extracts the feature amount of the node from the graph 120 by using, for example, Netwalk. When Netwalk is used, the model generation unit 13 may be combined with an existing prediction algorithm such as Gradient Boosting, for example.

Next, in the process of performing machine learning using the above-described teacher data, the model generation unit 13 determines an explanatory variable related to the growth potential of the intended company from the result obtained by extracting the features from the graph 120 as described above. A specific example of the explanatory variable will be described later. Specifically, the result obtained by extracting the features from the graph 120 is a static feature and a dynamic feature regarding a transaction relation and attributes of the intended company and the transaction company, or a feature amount of a node. Further, a result obtained by extracting features from the graph 120 is a feature amount of time-series data related to company activities, and is, for example, an explanatory variable related to a time-series change such as a fund or a stock price held in an account. Then, the model generation unit 13 generates the estimation model 130 including a criterion for estimating the growth potential of the intended company on the basis of the value of the explanatory variable. The model generation unit 13 determines the criterion by performing machine learning on the relation between the value of the explanatory variable and the value of the label in the teacher data.

For example, the model generation unit 13 determines an explanatory variable related to a time-series change in the transaction relation indicated by the transaction information 100. Examples of the explanatory variable related to the time-series change in the transaction relation include, but are not limited to, a deposit transaction amount average, the number of transactions with a customer, and the like. The model generation unit 13 determines an explanatory variable related to a time-series change in account deposit/withdrawal indicated by the account time-series information 103. Examples of the explanatory variable related to the time-series change in the account deposit/withdrawal include, but are not limited to, an increase (or decrease) rate of the balance of the account or increasing (or decreasing) periods of the balance of the account in a predetermined period. The model generation unit 13 determines an explanatory variable related to a time-series change in the company attribute indicated by the intended company attribute information 104. Examples of the explanatory variable related to the time-series change in the company attribute include, but are not limited to, sales or net profit compared to other companies.

When determining the explanatory variable as described above, the model generation unit 13 also determines the importance (contribution to the estimation result) in estimating the growth potential of the intended company for each of the plurality of explanatory variables. The model generation unit 13 may weight the value of each explanatory variable by the importance of the explanatory variable in the criterion for estimating the growth potential of the intended company described above. At this time, the model generation unit 13 may determine different importance for the same explanatory variable for each intended company from a difference in features regarding the transaction information 100, the account time-series information 103, and the intended company attribute information 104 between the intended companies. That is, for example, the model generation unit 13 may set the importance of a certain explanatory variable such that the estimation of the growth potential of the intended company A is set high, and the estimation of the growth potential of the intended company B is set low.

The model generation unit 13 stores the estimation model 130 generated or updated as described above in a nonvolatile storage device (not illustrated). The model generation unit 13 can gradually improve the estimation accuracy by updating (also referred to as relearning) the estimation model, for example, every predetermined time.

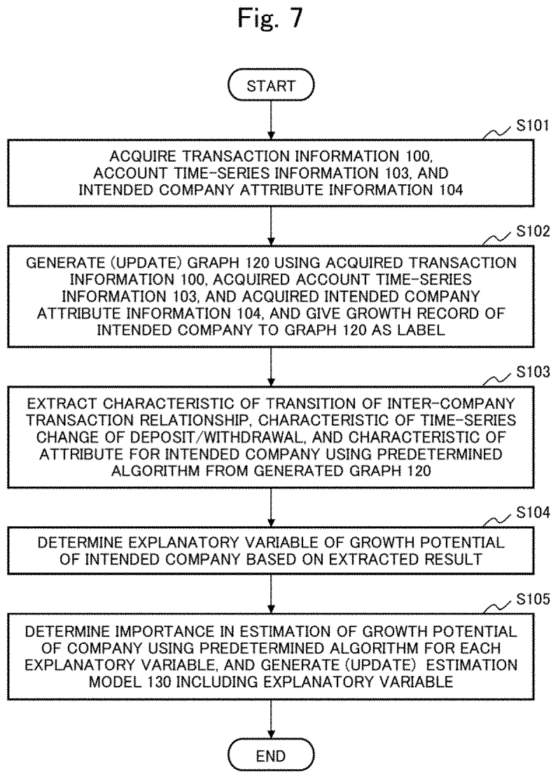

Next, an operation (processing) of generating the estimation model 130 (performing machine learning) by the growth potential estimation system 10 according to the present example embodiment will be described in detail with reference to a flowchart of FIG. 7.

The acquisition unit 11 acquires, from the outside, the transaction information 100, the account time-series information 103, and the intended company attribute information 104 related to a certain past period used as teacher data (Step S101). The graph generation unit 12 generates (updates) the graph 120 by using the transaction information 100, the account time-series information 103, and the intended company attribute information 104 acquired by the acquisition unit 11. Then, the graph generation unit 12 assigns a growth record of the intended company after a certain past period as a label to the graph 120 (Step S102).

The model generation unit 13 extracts, from the graph 120 generated by the graph generation unit 12, a feature of a transition of a company-to-company transaction relation, a feature of a time-series change such as deposit/withdrawal and a stock price, and a feature of an attribute for the intended company, using a predetermined algorithm (Step S103). The model generation unit 13 determines an explanatory variable of the growth potential of the intended company on the basis of the extraction result (Step S104).

The model generation unit 13 determines the importance in the estimation of the growth potential of the company for each explanatory variable using a predetermined algorithm, generates (updates) the estimation model 130 including the explanatory variable (Step S105), and ends the entire processing.

<Operation of Estimating Growth Potential of Intended Company>

Next, an operation in which the growth potential estimation system 10 according to the present example embodiment estimates the growth potential of the intended company using the generated or updated estimation model 130 will be described.

The acquisition unit 11 acquires the transaction information 100, the account time-series information 103, and the intended company attribute information 104 regarding the intended company from an external device (not illustrated), similarly to when the growth potential estimation system 10 generates the estimation model 130. However, the acquisition unit 11 does not acquire these pieces of information as the teacher data described above, but acquires these pieces of information as data of an estimation target of the growth potential regarding the intended company. For example, as described above, it is assumed that the estimation model 130 is generated on the basis of the transaction information 100, the account time-series information 103, and the intended company attribute information 104 regarding the periods t₁ to tₙ₋₁. In this case, the acquisition unit 11 acquires the transaction information 100, the account time-series information 103, and the intended company attribute information 104 regarding the period tₙ according to an instruction input by the user via the management terminal device 20, for example. The content of the transaction information 100, the account time-series information 103, and the intended company attribute information 104 regarding the period tₙ are similar to the transaction information 100, the account time-series information 103, and the intended company attribute information 104 regarding the periods t₁ to tₙ₋₁ illustrated in FIGS. 2 to 5.

The graph generation unit 12 generates the graph 120 representing the transaction information 100, the account time-series information 103, and the intended company attribute information 104 regarding at least one of the periods t₁ to tₙ₋₁ and the newly acquired information regarding the period tₙ. However, such information regarding at least one of the periods t₁ to tₙ₋₁ has already been acquired when the estimation model 130 is generated or updated. Note that the configuration of the graph 120 is as described above with reference to FIG. 6.

For example, it is assumed that each period of the periods t₁ to tₙ represents a quarter, and the graph generation unit 12 generates the graph 120 representing the transaction information 100, the account time-series information 103, and the intended company attribute information 104 for one year (that is, four consecutive quarters) as the teacher data described above. In this case, the graph generation unit 12 generates the graph 120 representing the transaction information 100, the account time-series information 103, and the intended company attribute information 104 regarding the periods tₙ₋₃ to tₙ as a graph of the growth potential estimation target.

More specifically, for example, it is assumed that the growth potential estimation system 10 is provided with the transaction information 100, the account time-series information 103, and the intended company attribute information 104 regarding the fourth quarter of 2019 as the latest information. Then, it is assumed that the transaction information 100, the account time-series information 103, and the intended company attribute information 104 up to the third quarter of 2019 are reflected in the estimation model 130. In this case, the graph generation unit 12 generates the graph 120 representing the transaction information 100, the account time-series information 103, and the intended company attribute information 104 regarding the first to fourth quarters of 2019 as a graph of an estimation target of the growth potential.

The estimation unit 14 illustrated in FIG. 1 estimates the growth potential of the intended company on the basis of the graph 120 regarding a period (also referred to as a second period) including the period tₙ, and the estimation model 130 reflecting the transaction information 100, the account time-series information 103, and the intended company attribute information 104 up to the period tₙ₋₁.

Similarly to the case where the model generation unit 13 generates or updates the estimation model 130, the estimation unit 14 extracts, from the graph 120 input from the graph generation unit 12, the features of the transition regarding the transaction relation between the intended company and the transaction company and the attributes of the intended company and the transaction company. At this time, the estimation unit 14 may use a predetermined algorithm such as TGFN, STAR, or Netwalk described above, for example.

The estimation unit 14 obtains a value of the explanatory variable identified by the estimation model 130 in the graph 120 on the basis of the feature extracted from the graph 120. The estimation unit 14 estimates the growth potential of the intended company by collating the obtained value of the explanatory variable with the criteria for estimating the growth potential of the intended company included in the estimation model 130.

The estimation unit 14 outputs a result of estimating the growth potential of the intended company and information indicating the reason for the estimation to the display control unit 15. The information indicating the reason for estimation is, for example, the value of the explanatory variable in the graph 120 to be estimated for the growth potential of the intended company, the importance of the explanatory variable, and the like.

The display control unit 15 displays the result of estimating the growth potential of the intended company and the information indicating the reason for the estimation, which are input from the estimation unit 14, on the display screen 200 of the management terminal device 20. That is, the display control unit 15 controls the management terminal device 20 so as to display the estimation result and the estimation reason by the estimation unit 14 on the display screen 200 of the management terminal device 20.

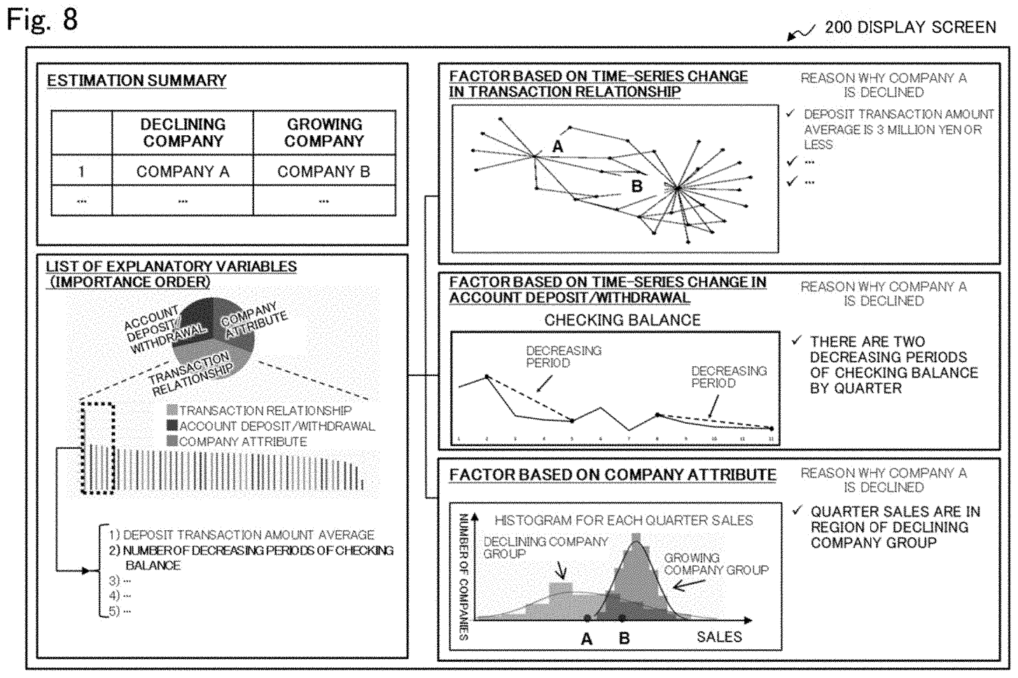

FIG. 8 is a diagram illustrating a mode in which the display control unit 15 according to the present example embodiment displays a result of estimating the growth potential of the intended company and information indicating the reason for the estimation on the display screen 200. The display control unit 15 generates and displays a graph in each window illustrated in FIG. 8 on the basis of the information input from the estimation unit 14. That is, the display control unit 15 controls the management terminal device 20 to display each graph illustrated in FIG. 8 on the display screen 200 of the management terminal device 20.

In the display screen 200 illustrated in FIG. 8, as a result of estimating the growth potential of the intended company, the upper left window displays a list of names of declining companies expected to decline in the future and a list of names of growing companies expected to grow in the future.

In the display screen 200 exemplified in FIG. 8, the lower left window displays a list of explanatory variables arranged in the order of importance (in the example of FIG. 8, it is expressed by the length of the bar graph) by a bar graph, and displays content (names) of explanatory variables whose values of importance are high (in the example of FIG. 8, the top five). Here, the explanatory variables having the top five values of the importance are, in order from the top, “deposit transaction amount average”, “decreasing periods of the checking balance”, “the ratio of customers whose deposit transaction amount is equal to or less than a certain amount”, “the number of transactions with customers”, and “the class of the quarter sales”. Note that, in FIG. 8, description of some explanatory variables is omitted for convenience of the paper surface. The lower left window is displayed by, for example, color-coding for each type of explanatory variable in such a way that the type (category) of each explanatory variable can be identified. In the example of FIG. 8, three types of “transaction relation”, “account deposit/withdrawal”, and “company attribute” are set as types of explanatory variables. Note that the types “transaction relation”, “account deposit/withdrawal”, and “company attribute” indicate explanatory variables related to the transaction information 100, the account time-series information 103, and the intended company attribute information 104 in order.

In the display screen 200 exemplified in FIG. 8, the right window specifically displays the estimation reason of the estimation result displayed in the upper left window. In the example of FIG. 8, the right window displays the reason why Company A is estimated to decline for each of “factor based on transition of transaction relation”, “factor based on time-series change in account deposit/withdrawal”, and “factor based on company attribute”.

According to the display screen 200 illustrated in FIG. 8, the estimation unit 14 specifies, as factors based on the transition of the transaction relation in which Company A is estimated to decline:
the deposit transaction amount average (explanatory variable) is equal to or lea than 3 million yen;
the ratio (explanatory variable) of customers with a deposit transaction amount equal to or lea than 3 million yen is 87.5% (in FIG. 8, illustration is omitted for convenience of the paper surface);
the number of transactions with customers (explanatory variable) is equal to or lea than 20 in a quarter (in FIG. 8, illustration is omitted for convenience of the paper surface).

According to the display screen 200 illustrated in FIG. 8, the estimation unit 14 specifies, as a factor based on the time-series change in the account deposit/withdrawal in which Company A is estimated to decline:
there are two decreasing periods of the checking balance by quarter.

According to the display screen 200 exemplified in FIG. 8, the estimation unit 14 specifies, as a factor based on the company attribute by which Company A is estimated to decline:
the quarter sales are in the region of the declining business group.

Note that the mode of being displayed on the display screen 200 illustrated in FIG. 8 is an example, and the display control unit 15 may display the result of estimating the growth potential of the intended company and the information indicating the estimation reason on the display screen 200 by a mode different from the mode illustrated in FIG. 8.

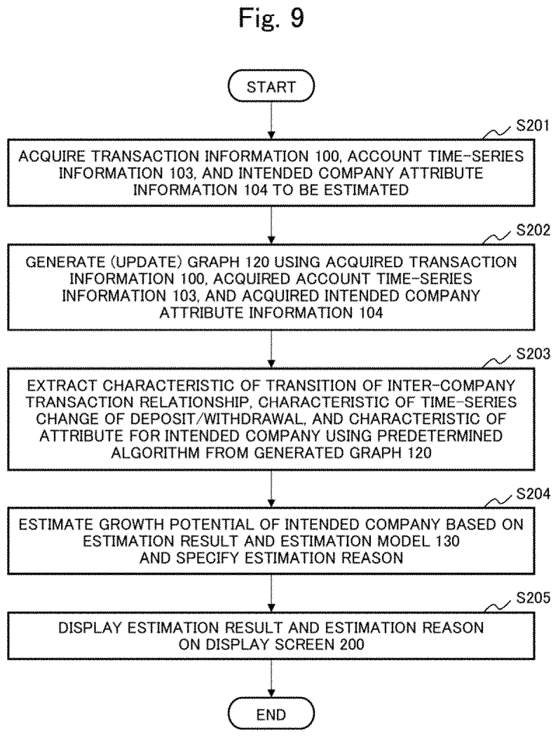

Next, an operation (processing) of estimating the growth potential of the intended company by the growth potential estimation system 10 according to the present example embodiment will be described in detail with reference to a flowchart of FIG. 9.

The acquisition unit 11 acquires the transaction information 100, the account time-series information 103, and the intended company attribute information 104 to be estimated from the outside (Step S201). The graph generation unit 12 generates (updates) the graph 120 by using the acquired transaction information 100, the acquired account time-series information 103, and the acquired intended company attribute information 104 (Step S202).

The estimation unit 14 extracts, from the graph 120 generated by the graph generation unit 12, the feature of the transition of the company-to-company transaction relation, the feature of the time-series change in deposit/withdrawal, and the feature of the attribute for the intended company using a predetermined algorithm (Step S203). The estimation unit 14 estimates the growth potential of the intended company on the basis of the feature extraction result from the graph 120 and the estimation model 130, and specifies the estimation reason (Step S204). The display control unit 15 displays the estimation result of the growth potential of the intended company by the estimation unit 14 and the estimation reason on the display screen 200 of the management terminal device 20 (Step S205), and the entire processing ends.

The growth potential estimation system 10 according to the present example embodiment can improve the accuracy of estimating the growth potential of a company. This is because the growth potential estimation system 10 estimates the growth potential of the intended company based on the estimation model 130 generated by using the result obtained by extracting the features of the time-series change from the information regarding the company activities of the intended company.

Hereinafter, effects achieved by the growth potential estimation system 10 according to the present example embodiment will be described in detail.

In order to estimate whether the intended company for which the growth potential is to be estimated will grow with high accuracy, it is necessary to estimate based on various growth factors that complicatedly affect each other. Such growth factors include, for example, a feature of a time-series change in a transaction relation between the intended company and a transaction company having a transaction relation, a feature of a time-series change in an attribute related to a company activity of the intended company or the transaction company, and the like. Therefore, in order to estimate the growth potential of the intended company with high accuracy, it is necessary to perform analysis after grasping the features of the time-series change regarding such company activities with high accuracy. However, in a general system that estimates the growth potential of an intended company, there is a problem that high estimation accuracy cannot be obtained because such a feature of the time-series change regarding the company activity cannot be sufficiently grasped.

In view of such a problem, the growth potential estimation system 10 according to the present example embodiment includes the estimation model 130 and the estimation unit 14, and operates as described above with reference to FIGS. 1 to 9, for example. That is, the estimation model 130 is a learned model representing a relation between the transaction information 100, the account time-series information 103, and the intended company attribute information 104 of the intended company in the first period, and the growth potential of the intended company after the first period. The estimation unit 14 estimates the growth potential of the intended company after the second period on the basis of the transaction information 100, the account time-series information 103, the intended company attribute information 104, and the estimation model 130 in the second period after the first period. However, the transaction information 100, the account time-series information 103, and the intended company attribute information 104 are information indicating a time-series change regarding a company activity.

The growth potential estimation system 10 according to the present example embodiment generates a graph 120 having a time-series structure change, which includes nodes and edges and represents the transaction information 100, the account time-series information 103, and the intended company attribute information 104. Then, the growth potential estimation system 10 uses the above-described algorithms such as TGFN, STAR, and Netwalk capable of extracting and analyzing the features of the generated graph 120, thereby achieving grasping the features of the time-series change regarding the company activities with high accuracy. As a result, the growth potential estimation system 10 can increase the accuracy of estimating the growth potential of the company.

In the process of generating the estimation model 130, the growth potential estimation system 10 according to the present example embodiment determines explanatory variables related to the estimation of the growth potential of the intended company, and further determines the importance (contribution) in the estimation of the growth potential of the intended company for each explanatory variable. Then, the growth potential estimation system 10 weights the explanatory variable by its importance to estimate the growth potential of the intended company. As a result, as compared with a case where estimation is performed without calculating the importance, the growth potential estimation system 10 performs estimation in which features of company activities are captured more accurately, and thus, it is possible to improve accuracy of estimating the growth potential of a company.

In a general system that estimates an event using a learned model, an estimation process is converted into a black box, and only an estimation result is presented without presenting a reason for estimation. Therefore, it is difficult for a user to grasp the basis of the estimation result output by the system. On the other hand, the growth potential estimation system 10 according to the present example embodiment displays the reason for the estimation of the growth potential of the intended company based on the value of the explanatory variable on the display screen 200 of the management terminal device 20. Then, at that time, for example, as illustrated in FIG. 8, the growth potential estimation system 10 displays the reason for the estimation of the growth potential in a mode of displaying the names of the explanatory variables side by side in order of importance and displaying the values of the explanatory variables. As a result, the growth potential estimation system 10 can improve the explanation about the reason for the estimation of the growth potential.

### Second Example Embodiment

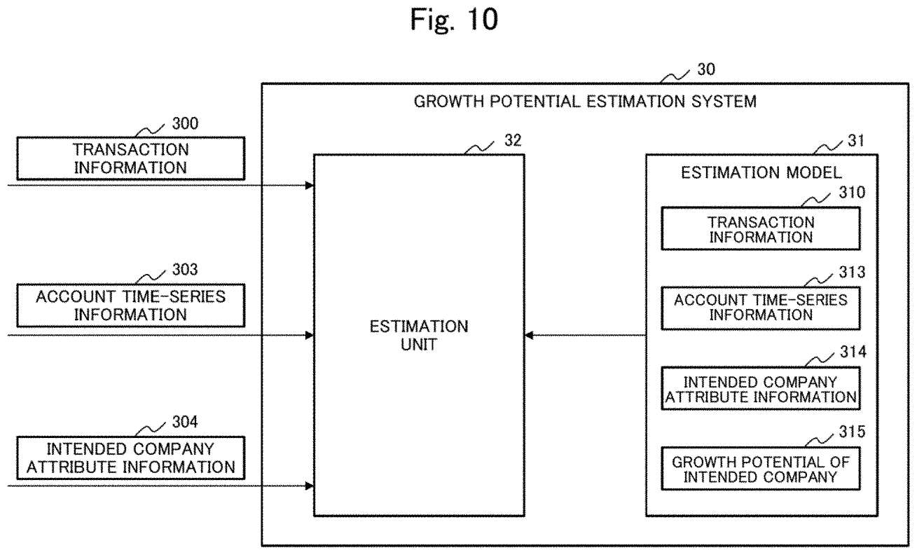

FIG. 10 is a block diagram illustrating a configuration of a growth potential estimation system 30 according to a second example embodiment of the present invention. The growth potential estimation system 30 includes an estimation unit 32 that uses an estimation model 31. However, the estimation unit 32 is an example of an estimation means.

The estimation model 31 represents a relation between transaction information 310, account time-series information 313, and intended company attribute information 314 of the intended company in the first period, and a growth potential 315 of the intended company after the first period. The first period is, for example, any consecutive period in the periods t₁ to tₙ₋₁ in the first example embodiment. For example, similarly to the estimation model 130 according to the first example embodiment, the estimation model 31 is a learned model representing a result of performing machine learning on a relation among the transaction information 310, the account time-series information 313, the intended company attribute information 314, and the growth potential 315 of the intended company.

The transaction information 310 represents a time-series change in a company-to-company transaction relation of the intended company, and may be, for example, information similar to the transaction information 100 described with reference to FIGS. 2 and 3 with respect to the first example embodiment. The account time-series information 313 represents a time-series change in deposits and withdrawals of account of the intended company, and may be, for example, information similar to the account time-series information 103 described with reference to FIG. 4 with respect to the first example embodiment. The intended company attribute information 314 represents a time-series change in the attribute of the intended company, and may be, for example, information similar to the intended company attribute information 104 described with reference to FIG. 5 with respect to the first example embodiment.

The estimation unit 32 estimates the growth potential of the intended company after the second period on the basis of transaction information 300, account time-series information 303, intended company attribute information 304, and the estimation model 31 in the second period after the first period.

When estimating the growth potential of the intended company, the estimation unit 32 extracts the features of the transition regarding the transaction relation between companies and the attribute of the company from the transaction information 300, the account time-series information 303, and the intended company attribute information 304, similarly to the estimation unit 14 according to the first example embodiment. At this time, the estimation unit 32 can use a predetermined algorithm (TGFN, STAR, Netwalk, etc.) described in the first example embodiment.

The growth potential estimation system 30 according to the present example embodiment can efficiently improve the accuracy of estimating the growth potential of a company. This is because the growth potential estimation system 30 estimates the growth potential of the intended company based on the estimation model 31 generated by using the result obtained by extracting the features of the time-series change from the information regarding the company activities of the intended company.

<Hardware Configuration Example>

Each unit in the growth potential estimation system 10 illustrated in FIG. 1 or the growth potential estimation system 30 illustrated in FIG. 10 in each of the above-described example embodiments can be achieved by dedicated hardware (HW) (electronic circuit). In FIGS. 1 and 10, at least the following configuration can be regarded as a function (processing) unit (software module) of a software program.
Acquisition Unit 11,
Graph Generation Unit 12,
Model Generation Unit 13,
Estimation Units 14 and 32, and
Display control units 15.

However, the division of each unit illustrated in these drawings is a configuration for convenience of description, and various configurations can be assumed at the time of implementation. An example of a hardware environment in this case will be described with reference to FIG. 11.

FIG. 11 is a diagram exemplarily describing a configuration of the information processing system 900 (computer system) capable of implementing the growth potential estimation system 10 according to the first example embodiment or the growth potential estimation system 30 according to the second example embodiment of the present invention. That is, FIG. 11 illustrates a configuration of at least one computer (information processing device) capable of achieving the growth potential estimation systems 10 and 30 illustrated in FIGS. 1 and 10, and illustrates a hardware environment capable of achieving each function in the above-described example embodiment.

The information processing system 900 illustrated in FIG. 11 includes the following hardware as components, but may not include some of the following components.
Central Processing Unit (CPU) 901,
Read Only Memory (ROM) 902,
Random Access Memory (RAM) 903,
Hard Disk (storage device) 904,
Communication Interface 905 with an external device,
Bus 906 (communication line),
Reader/Writer 908 capable of reading and writing data stored in a recording medium 907 such as a CD-ROM

### (Compact_Disc_Read_Only_Memory);

Input/Output Interface 909 such as a monitor, a speaker, or a keyboard.

That is, the information processing system 900 including the above-described components is a general computer to which these components are connected via the bus 906. The information processing system 900 may include a plurality of CPUs 901 or may include a CPU 901 configured by multiple cores. The information processing system 900 may include a GPU (Graphical Processing Unit) (not illustrated) in addition to the CPU 901.

Then, the present invention described using the above-described example embodiment as an example supplies a computer program capable of achieving the following functions to the information processing system 900 illustrated in FIG. 11. The function is the above-described configuration in the block configuration diagram (FIGS. 1 and 10) referred to in the description of the example embodiment or the function of the flowchart (FIGS. 7 and 9). Thereafter, the present invention is achieved by reading, interpreting, and executing the computer program on the CPU 901 of the hardware. The computer program supplied into the device may be stored in a readable/writable volatile memory (RAM 903) or a nonvolatile storage device such as the ROM 902 or the hard disk 904.

In the above case, a general procedure can be adopted at present as a method of supplying the computer program into the hardware. Examples of the procedure include a method of installing the program in the apparatus via various recording media 907 such as a CD-ROM, a method of downloading the program from the outside via a communication line such as the Internet, and the like. In such a case, the present invention can be understood to be constituted by a code constituting the computer program or the recording medium 907 storing the code.

The present invention has been described above using the above-described example embodiments as schematic examples. However, the present invention is not limited to the above-described example embodiments. That is, the present invention can apply various aspects that can be understood by those skilled in the art within the scope of the present invention.

Note that some or all of the above-described example embodiments can also be described as the following supplementary notes. However, the present invention exemplarily described by the above-described example embodiments is not limited to the following.

(Supplementary Note 1)

A growth potential estimation system including:

an estimation means configured to estimate a growth potential of an intended company after a second period based on an estimation model representing a relation between transaction information, account time-series information, and intended company attribute information of the intended company in a first period, and a growth potential of the intended company after the first period, and the transaction information, the account time-series information, and the intended company attribute information in the second period after the first period, in which

the transaction information represents a time-series change in a company-to-company transaction relation of the intended company,

the account time-series information represents a time-series change in deposits and withdrawals of account of the intended company, and

the intended company attribute information represents a time-series change in an attribute of the intended company.

(Supplementary Note 2)

The growth potential estimation system according to Supplementary Note 1, further including: a display control means configured to control a display device to display a reason for estimation of the growth potential of the intended company.

(Supplementary Note 3)

The growth potential estimation system according to Supplementary Note 2, in which the transaction information includes at least one of capital, sales, net profit, and a transaction duration or a transaction start timing with the intended company, regarding a transaction company that performs a transaction with the intended company.

(Supplementary Note 4)

The growth potential estimation system according to Supplementary Note 2 or 3, in which the transaction information includes at least one of a transaction amount, a number of transactions, and a transaction product with a transaction company that performs a transaction with the intended company.

(Supplementary Note 5)

The growth potential estimation system according to any one of Supplementary Notes 2 to 4, in which the account time-series information includes at least one of a balance of an account of the intended company, an amount of money deposited in the account, and an amount of money withdrawn from the account.

(Supplementary Note 6)

The growth potential estimation system according to any one of Supplementary Notes 2 to 5, in which the intended company attribute information includes at least one of capital, sales, and net profit of the intended company.

(Supplementary Note 7)

The growth potential estimation system according to any one of Supplementary Notes 2 to 6, further including: a graph generation means configured to generate a graph representing the transaction information.

(Supplementary Note 8)

The growth potential estimation system according to Supplementary Note 7, in which the graph includes a node representing a company including the intended company and an edge representing the company-to-company transaction relation.

(Supplementary Note 9)

The growth potential estimation system according to Supplementary Note 7 or 8, further including: a model generation means configured to generate the estimation model based on, the transaction information, the account time-series information, and the intended company attribute information in the first period, and the growth potential of the intended company after the first period.

(Supplementary Note 10)

The growth potential estimation system according to Supplementary Note 9, in which the model generation means extracts a feature of a time-series change in the company-to-company transaction relation using a predetermined algorithm from the graph to which a growth record of the intended company indicated by the intended company attribute information is assigned as a label, and then determines an explanatory variable of the growth potential of the intended company based on an extraction result, thereby generating the estimation model including the explanatory variable.

(Supplementary Note 11)

The growth potential estimation system according to Supplementary Note 10, in which the graph generation means generates the graph including the account time-series information and the intended company attribute information, and

the model generation means determines, from the graph, the explanatory variable related to a time-series change in deposits and withdrawals of account of the intended company and the explanatory variable related to an attribute of the intended company.

(Supplementary Note 12)

The growth potential estimation system according to Supplementary Note 10 or 11, in which the model generation means determines an importance in estimation of the growth potential of the intended company for each of a plurality of the explanatory variables, and

the estimation means estimates the growth potential of the intended company based on the importance.

(Supplementary Note 13)

The growth potential estimation system according to Supplementary Note 12, in which the model generation means determines the importance different for each of the intended companies for the same explanatory variable.

(Supplementary Note 14)

The growth potential estimation system according to Supplementary Note 12 or 13, in which the display control means controls the display device so as to display names of the explanatory variables side by side in an order of the importance and display the reason for estimation in a mode of displaying values of the explanatory variables.

(Supplementary Note 15)

A growth potential estimation device including:

an estimation means configured to estimate a growth potential of an intended company after a second period based on an estimation model representing a relation among transaction information, account time-series information, and intended company attribute information of the intended company in a first period, and a growth potential of the intended company after the first period, and the transaction information, the account time-series information, and the intended company attribute information in the second period after the first period, in which

the transaction information represents a time-series change in a company-to-company transaction relation of the intended company,

the account time-series information represents a time-series change in deposits and withdrawals of account of the intended company, and

the intended company attribute information represents a time-series change in an attribute of the intended company.

(Supplementary Note 16)

A growth potential estimation method including: estimating, by an information processing system, a growth potential of an intended company after a second period based on an estimation model representing a relation between transaction information, account time-series information, and intended company attribute information of the intended company in a first period, and a growth potential of the intended company after the first period, and the transaction information, the account time-series information, and the intended company attribute information in the second period after the first period, in which

the transaction information represents a time-series change in a company-to-company transaction relation of the intended company,

the account time-series information represents a time-series change in deposits and withdrawals of account of the intended company, and

the intended company attribute information represents a time-series change in an attribute of the intended company.

(Supplementary Note 17)

A recording medium having stored therein a growth potential estimation program causing a computer to execute:

estimating processing of estimating a growth potential of an intended company after a second period based on an estimation model representing a relation between transaction information, account time-series information, and intended company attribute information of the intended company in a first period, and a growth potential of the intended company after the first period, and the transaction information, the account time-series information, and the intended company attribute information in the second period after the first period, in which

the transaction information represents a time-series change in a company-to-company transaction relation of the intended company,

the account time-series information represents a time-series change in deposits and withdrawals of account of the intended company, and

the intended company attribute information represents a time-series change in an attribute of the intended company.

### REFERENCE SIGNS LIST

10 growth potential estimation system
100 transaction information
101 transaction result information
102 transaction company attribute information
103 account time-series information
104 intended company attribute information
11 acquisition unit
12 graph generation unit
120 graph
13 model generation unit
130 estimation model
14 estimation unit
15 display control unit
20 management terminal device
200 display screen
30 growth potential estimation system
300 transaction information
303 account time-series information
304 intended company attribute information
31 estimation model
32 estimation unit
900 information processing system
901 CPU
902 ROM
903 RAM
904 hard disk (storage device)
905 communication interface
906 bus
907 recording medium
908 reader/writer
909 input/output interface

What is claimed is:

1. A growth potential estimation system comprising:
a memory storing instructions; and
one or more processors configured to execute the instructions to:
estimate a growth potential of an intended company after a second period based on an estimation model representing a relation between transaction information, account time-series information, and intended company attribute information of the intended company in a first period, and a growth potential of the intended company after the first period, and the transaction information, the account time-series information, and the intended company attribute information in the second period after the first period, wherein
the transaction information represents a time-series change in a company-to-company transaction relation of the intended company,
the account time-series information represents a time-series change in deposits and withdrawals of account of the intended company, and
the intended company attribute information represents a time-series change in an attribute of the intended company.

2. The growth potential estimation system according to claim 1, wherein the one or more processors are further configured to execute the instructions to:
control a display device to display a reason for estimation of the growth potential of the intended company.

3. The growth potential estimation system according to claim 2, wherein
the transaction information includes at least one of capital, sales, net profit, and a transaction duration or a transaction start timing with the intended company, regarding a transaction company that performs a transaction with the intended company.

4. The growth potential estimation system according to claim 2, wherein
the transaction information includes at least one of a transaction amount, a number of transactions, and a transaction product with a transaction company that performs a transaction with the intended company.

5. The growth potential estimation system according to claim 2, wherein
the account time-series information includes at least one of a balance of an account of the intended company, an amount of money deposited in the account, and an amount of money withdrawn from the account.

6. The growth potential estimation system according to claim 2, wherein
the intended company attribute information includes at least one of capital, sales, and net profit of the intended company.

7. The growth potential estimation system according to claim 2, wherein the one or more processors are further configured to execute the instructions to:
generate a graph representing the transaction information.

8. The growth potential estimation system according to claim 7, wherein
the graph includes a node representing a company including the intended company and an edge representing the company-to-company transaction relation.

9. The growth potential estimation system according to claim 7, wherein the one or more processors are further configured to execute the instructions to:
generate the estimation model based on, the transaction information, the account time-series information, and the intended company attribute information in the first period, and the growth potential of the intended company after the first period.

10. The growth potential estimation system according to claim 9, wherein the one or more processors are further configured to execute the instructions to:
extract a feature of a time-series change in the company-to-company transaction relation using a predetermined algorithm from the graph to which a growth record of the intended company indicated by the intended company attribute information is assigned as a label, and then determines an explanatory variable of the growth potential of the intended company based on an extraction result, thereby generating the estimation model including the explanatory variable.

11. The growth potential estimation system according to claim 10, wherein the one or more processors are further configured to execute the instructions to:
generate the graph including the account time-series information and the intended company attribute information, and
determine, from the graph, the explanatory variable related to a time-series change in deposits and withdrawals of account of the intended company and the explanatory variable related to an attribute of the intended company.

12. The growth potential estimation system according to claim 10, wherein the one or more processors are further configured to execute the instructions to:
determine an importance in estimation of the growth potential of the intended company for each of a plurality of the explanatory variables, and
estimate the growth potential of the intended company based on the importance.

13. The growth potential estimation system according to claim 12, wherein the one or more processors are further configured to execute the instructions to:
determine the importance different for each of the intended companies for the same explanatory variable.

14. The growth potential estimation system according to claim 12, wherein the one or more processors are further configured to execute the instructions to:
control the display device so as to display names of the explanatory variables side by side in an order of the importance and display the reason for estimation in a mode of displaying values of the explanatory variables.

15. (canceled)

16. A growth potential estimation method comprising:
estimating, by an information processing system, a growth potential of an intended company after a second period based on an estimation model representing a relation between transaction information, account time-series information, and intended company attribute information of the intended company in a first period, and a growth potential of the intended company after the first period, and the transaction information, the account time-series information, and the intended company attribute information in the second period after the first period, wherein
the transaction information represents a time-series change in a company-to-company transaction relation of the intended company,
the account time-series information represents a time-series change in deposits and withdrawals of account of the intended company, and
the intended company attribute information represents a time-series change in an attribute of the intended company.

17. A non-transitory computer-readable recording medium having stored therein a growth potential estimation program causing a computer to execute:
estimating processing of estimating a growth potential of an intended company after a second period based on an estimation model representing a relation between transaction information, account time-series information, and intended company attribute information of the intended company in a first period, and a growth potential of the intended company after the first period, and the transaction information, the account time-series information, and the intended company attribute information in the second period after the first period, wherein
the transaction information represents a time-series change in a company-to-company transaction relation of the intended company,
the account time-series information represents a time-series change in deposits and withdrawals of account of the intended company, and
the intended company attribute information represents a time-series change in an attribute of the intended company.
